(19) United States
(12) Patent Application Publication
(10) Pub. No.: US 2010/0129068 A1
(43) Pub. Date: May 27, 2010

(54) DEVICE AND METHOD FOR DETECTING THE ORIENTATION OF AN ELECTRONIC APPARATUS

(75) Inventors: Ivo Binda, Voghera (IT); Michele Tronconi, San Martino Siccomario (IT)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMICROELECTRONICS S.R.L., Agrate Brianza (IT)

(21) Appl. No.: 12/624,203

(22) Filed: Nov. 23, 2009

(30) Foreign Application Priority Data
Nov. 24, 2008 (IT) TO2008A000865

(51) Int. Cl. G03B 17/00

(52) U.S. Cl. 396/50

(57) ABSTRACT

A device for detecting orientation includes: an inertial device, having a plurality of independent detection axes and configured to supply inertial signals indicating effects of the force of gravity according to respective detection axes; and a processing unit for configured to process the inertial signals. The processing unit includes an interrupt-generator module having a threshold-comparison stage, for configured to compare the inertial signals with respective thresholds, and a logic module, coupled to the threshold-comparison stage and configured to generate an interrupt signal on an interrupt terminal accessible from outside in response to the permanence of at least one of the inertial signals below the respective threshold for a time interval.

### BACKGROUND

1. Technical Field

The present disclosure relates to a device and to a method for detecting the orientation of an electronic apparatus.

2. Description of the Related Art

As is known, the integration of MEMS sensors in electronic devices is becoming increasingly widespread because it enables numerous functionalities to be made available in a simple and intuitive or even automatic way, considerably extending the range of operations that can be carried out. For example, it is possible to implement an interface that enables commands to be imparted to a computer through movement in space, by varying the position or the inclination. Likewise, it is possible to control portable devices, such as palm-top computers, cell phones, photographic cameras, camcorders, audio/video reproducers, and the like.

In particular, some functions do not require more than an approximate estimate of the position or orientation in space, and it is not necessary to supply precise measurements. For example, a photographic camera, or an apparatus that incorporates the function of photographic camera, can generally be used in a “landscape” configuration, in which a picture is taken that has its major side that is substantially horizontal, and a “portrait” position, in which the major side of the image is vertical. The use of a MEMS inertial sensor as an inclinometer enables the orientation of the device to be determined automatically. During memory saving, it is hence possible to include data regarding the orientation of the image itself, which can be used when it is being displayed on or transferred to a medium external to the electronic device in order to determine the original orientation.

Additionally, a MEMS inertial sensor can be incorporated in an image-viewer device to determine the orientation thereof during use and accordingly rotate the images that are displayed.

Even though it is not indispensable to calculate at each moment the value of the total acceleration, processing the data that can be detected through the inertial sensor involves a considerable use of resources. This is disadvantageous for at least two reasons. The first is that the conventional use of the inertial sensor significantly reduces the computing power available for other applications, which increasingly more frequently occupy the system resources in an intensive way. The second reason is linked to power consumption, which, among other things, affects to a considerable extent the autonomy and cost of operation. The minimization of the power consumption is a primary target practically in every sector of modern electronics and, in particular, for portable devices. The higher power consumption of using an unnecessary processing complexity is not justified.

### BRIEF SUMMARY

Embodiments include a device and a method for detecting the orientation of an electronic apparatus that are free from the limitations described.

### BRIEF DESCRIPTION OF THE SEVERAL VIEWS OF THE DRAWINGS

For a better understanding of the disclosure, some embodiments thereof are now described, purely by way of non-limiting example and with reference to the attached drawings, wherein:

FIG. 1 is a right-hand side view of a portable electronic apparatus, in particular a digital photographic camera, in a first operating configuration;

FIG. 2 is a front view of the electronic apparatus of FIG. 1;

FIG. 3 is a simplified block diagram of the electronic apparatus of FIG. 1, incorporating a device for detecting orientation in accordance with an embodiment of the present disclosure;

FIGS. 4a and 4b are front views of an image sensor incorporated in the electronic apparatus of FIGS. 1 and 2, in two different operating configurations;

FIG. 5 is a more detailed block diagram of the device for detecting orientation of FIG. 3;

FIG. 6 is a block diagram in further detail of a part of the device for detecting orientation of FIG. 3;

FIGS. 7 and 8 are tables used in the device for detecting orientation of FIG. 3; and

FIG. 9 is a block diagram of a device for detecting orientation in accordance with another embodiment of the present disclosure.

### DETAILED DESCRIPTION

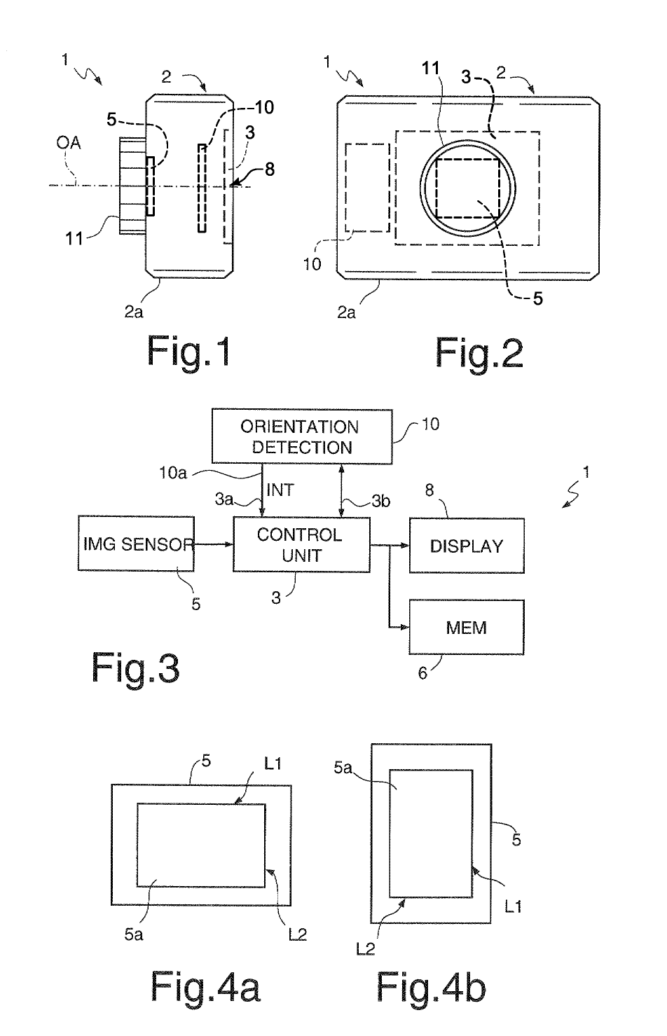

FIGS. 1-3 show a portable electronic apparatus, provided with an orientation detecting function and designated as a whole by the reference number 1. In the embodiment described herein, in particular, the electronic apparatus 1 is a digital photographic camera, but could, in other embodiments, be of a different type, such as a camcorder, a video player, a cell phone or a palmtop, just to mention some examples.

The electronic apparatus 1 comprises a body 2, a control unit 3, an image sensor 5 of a digital type, a nonvolatile-memory unit 6, a display 8, and an orientation detecting device 10.

The body 2 comprises a base 2a that normally faces downwards. The body 2 houses inside it the image sensor 5, the memory unit 6, and the orientation detecting device 10. The display 8 is set on the back of the body 2 so as to be visible by a user when he is taking a photograph.

The image sensor 5 is, for example, a CCD or CMOS sensor and is arranged perpendicular to an optical axis OA of a lens 11 mounted on the body 2. In addition, the image sensor 5 has a rectangular shape and, during use of the electronic apparatus 1, is normally set in a “landscape” configuration or in a “portrait” configuration. More precisely, in the “landscape” configuration (FIG. 4a), major sides L1 of the image sensor 5 are substantially horizontal, and minor sides L2 are often, but not necessarily, vertical. In the “portrait” configuration (FIG. 4b), the minor sides L2 are substantially horizontal and the major sides L1 are often, but not necessarily, vertical.

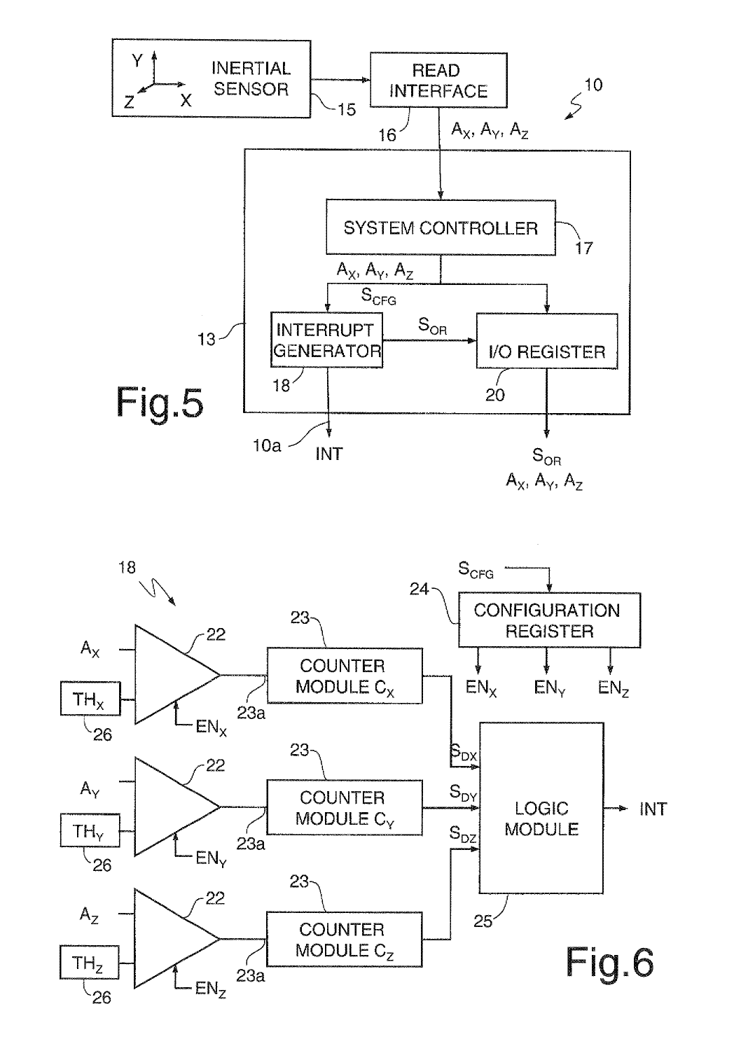

The orientation detecting device 10 is mounted on a board (not shown) so as to be rigidly fixed to the body 2 of the electronic apparatus 1. In addition, the orientation detecting device 10 is communicably coupled to an interrupt input 3a and to data inputs 3b of the control unit 3. More precisely, the orientation detecting device 10 has an interrupt terminal 10a accessible from outside and connected to the interrupt input 3a. As is shown in FIG. 5, the orientation detecting device 10 comprises a dedicated processing unit 13 (distinct from the control unit 3), an inertial sensor 15, and a read interface 16, for coupling the inertial sensor 15 to the processing unit 13. In one embodiment, the inertial sensor 15 is a triaxial microelectromechanical accelerometer (or MEMS accelerometer), having independent detection axes X, Y, Z, and supplies signals each indicating the effect of Earth's gravity force according to a respective one of the three detection axes X, Y, Z.

In one embodiment, the detection axes X, Y are parallel to a plane of the image sensor 5. In addition, the detection axis X is substantially horizontal when the electronic apparatus 1 is in a respective first operating position (“landscape”), whereas the detection axis Y is substantially horizontal in a second operating position (“portrait”). Both of the detection axes X, Y are substantially horizontal, with the detection axis Z substantially vertical, when the electronic apparatus 1 is in a third operating position (“plane”).

The read interface 16 converts the signals supplied by the inertial sensor 15 into numeric inertial signals A_{X}, A_{Y}, A_{Z} for respective detection axes X, Y, Z of the inertial sensor 15 itself.

In addition, the processing unit 13 comprises a control module 17, an interrupt-generator module 18, and an input/output (I/O) register 20.

The control module 17 receives the inertial signals A_{X}, A_{Y}, A_{Z} from the read interface 16 and determines the magnitude and sign thereof. Hereinafter, reference is made to the magnitude of the inertial signals A_{X}, A_{Y}, A_{Z}, unless otherwise specified. The inertial signals A_{X}, A_{Y}, A_{Z} are forwarded to the interrupt-generator module 18 and loaded (in magnitude and sign) into the I/O register 20.

The control module 17 is designed to execute also supervision operations. Among other things, the control module 17 supplies to the interrupt-generator module 18 a configuration string S_{CFG}, which determines an operating mode thereof, as described hereinafter.

The interrupt-generator module 18 processes the inertial signals A_{X}, A_{Y}, A_{Z} to provide control functions, in particular to determine the orientation of the electronic apparatus 1 in a reference system fixed with respect to the Earth. In the embodiment described, an interrupt signal INT is generated and made available on the interrupt terminal 10a following upon changes between the various detectable operating positions and indeterminate positions, which cause state transitions as described hereinafter. The interrupt signal INT is sent to the interrupt input 3a of the control unit 3 of the electronic apparatus 1 (see also FIG. 3). By “generation” or “sending” of the interrupt signal INT is meant that an output of the interrupt-generator module 18 connected to the interrupt input 3a of the control unit 3 is brought from an inactive value (for example, “0”) to an active value (for example, “1”).

In greater detail, in one operating mode, the interrupt-generator module 18 determines whether the direction of at least one of the detection axes X, Y, Z of the inertial sensor 15 has become substantially horizontal and in response sends the interrupt signal INT to the interrupt input 3a of the control unit 3. In a different operating mode, the interrupt signal INT is generated when the electronic apparatus 1 is oriented in such a way that two of the detection axes X, Y, Z are substantially horizontal simultaneously.

At the same time, the interrupt-generator module 18 loads an orientation string S_{OR} into the I/O register 20. The orientation string S_{OR} contains information on orientation of the detection axes X, Y, Z of the inertial sensor 15 and hence of the electronic apparatus 1. A main field S_{ORP} of the orientation string S_{OR} indicates whether the electronic apparatus 1 is in the first, second or third operating position. Three further sign fields S_{ORX}, S_{ORY}, S_{ORZ} of the orientation string S_{OR} contain values on magnitude and sign of the inertial signals A_{X}, A_{Y}, A_{Z}. In practice, the sign fields S_{ORX}, S_{ORY}, S_{ORZ} supply further information regarding the orientation of the electronic apparatus 1, in particular the axis or detection axes that are not substantially horizontal. For example, in a biaxial operating mode, the first operating position (“landscape”) is defined by the detection axis X being substantially horizontal. Likewise, in a triaxial operating mode, the first operating position (“landscape”) is defined by the detection axis X and the detection axis Z being substantially horizontal. In both cases, the value of sign in the sign field S_{ORY}, for the inertial signal A_{Y}, indicates whether the detection axis Y is facing upwards (positive sign) or downwards (negative sign). The same applies of course for the values contained in the sign fields S_{ORX}, S_{ORZ}, respectively, for the inertial signals A_{X}, A_{Z}. This type of information (non-horizontal orientation of the detection axes) is thus available to be exploited by applications that require it.

Basically, the interrupt-generator module 18 compares the modules of the inertial signals A_{X}, A_{Y}, A_{Z} with respective thresholds TH_{X}, TH_{Y}, TH_{Z} and determines that a detection axis X, Y, Z of the inertial sensor 15 is substantially horizontal if the corresponding inertial signal A_{X}, A_{Y}, A_{Z} remains below the respective threshold TH_{X}, TH_{Y}, TH_{Z} for a time interval T. When one of the detection axes is approximately horizontal and the electronic apparatus 1 is at rest, in fact, the component due to the acceleration of gravity along that detection axis is negligible, in so far as it is approximately perpendicular. In one operating mode, as already mentioned, the interrupt signal INT is generated when the electronic apparatus 1 is brought from one to another of the first, second, and third operating positions. Assume, for example, that the electronic apparatus 1 is initially in the first operating position (“landscape”), in which the detection axis X is substantially horizontal (as likewise the detection axis Z). The electronic apparatus 1 is then rotated so as to be brought into the second operating position (“portrait”) with the detection axis Y substantially horizontal (for example, the electronic apparatus 1 is turned about the detection axis Z, which remains horizontal). During displacement, the interrupt-generator module 18 detects that the inertial signal A_{X} increases until it exceeds the threshold TH_{X}, since the effect of the acceleration of gravity along the detection axis X increases. Instead, the inertial signal A_{Y} decreases and goes below the respective threshold TH_{Y}. If the second operating position is kept stable during the time interval T, the interrupt-generator module 18 sends the interrupt signal INT to the control unit 3 and loads a new orientation string S_{OR} into the I/O register 20.

In response to the interrupt signal INT, the control unit 3 of the electronic apparatus 1 (FIG. 3) executes an updating procedure. In particular, the sequence of operations being executed is temporarily suspended, and the control unit 3 fetches the orientation string S_{OR} from the I/O register 20. In one embodiment, also the current values of the inertial signals A_{X}, A_{Y} are read from the I/O register 20. Then, the configuration of the apparatus 1 is updated, and the program being executed is resumed. The effect of the updating procedure may depend upon the program executed by the control unit 3. For example, in the case of a shooting program of a photographic camera, the information on the image orientation of the image to be acquired is modified in accordance with the displacement between the first and the second operating positions and then saved together with the image. In the case of an image-display program, the orientation of the images on the display 8 is modified if the electronic apparatus 1 is rotated. In some cases, orientation of the apparatus 1 may be temporarily indeterminate, since none of the inertial signals A_{X}, A_{Y}, A_{Z} is below the respective threshold TH_{X}, TH_{Y}, TH_{Z}. According to one embodiment, in these conditions the orientation detecting device 10 does not react. Hence, in the absence of interrupt signals INT, the control unit 3 does not change its configuration, nor the sequence of operations being executed.

As has been mentioned previously, the interrupt-generator module 18 is configurable through the configuration string S_{CFG} so as to work in different operating modes.

In one (biaxial) operating mode, only the inertial signals A_{X}, A_{Y} for two of the detection axes (for example X, Y) are used, while the third detection axis (for example Z) is disabled in order to reduce the power consumption, or, alternatively, it is used for different functions.

In a different (triaxial) operating mode, all the inertial signals A_{X}, A_{Y}, A_{Z} are processed, and the first, second, and third operating positions are identified when pairs of inertial signals A_{X}, A_{Y}, A_{Z} are simultaneously lower than the respective thresholds TH_{X}, TH_{Y}, TH_{Z}.

According to one embodiment, represented in FIG. 6, the interrupt-generator module 18 comprises three comparators 22, each co-operating with a respective counter module 23 to define a threshold-comparison stage, a configuration register 24, and a logic module 25. The comparators 22 are selectively activatable by respective enable signals EN_{X}, EN_{Y}, EN_{Z}, loaded by the control module 17 into the configuration register 24 with the configuration string S_{CFG}.

In addition, each of the comparators 22 receives at an input a respective inertial signal A_{X}, A_{Y}, A_{Z} and the corresponding threshold TH_{X}, TH_{Y}, TH_{Z}. The thresholds TH_{X}, TH_{Y}, TH_{Z} are supplied by programmable threshold-generator modules 26.

The outputs of the comparators 22 are connected to start/stop inputs 23a of respective counter modules 23. In particular, the counter modules 23 are controlled so as to be activated selectively when the respective inertial signal A_{X}, A_{Y}, A_{Z} is below (in magnitude) the corresponding threshold TH_{X}, TH_{Y}, TH_{Z} and so as to be reset otherwise. The counter modules 23 are configured so as to switch the respective outputs when a count value, incremented according to a timing signal not shown, reaches or exceeds a respective count threshold C_{X}, C_{Y}, C_{Z}, which, in one embodiment, is programmable by the control unit 3 and the control module 17. The counter modules 23 can have different count thresholds C_{X}, C_{Y}, C_{Z}. In this way, the detection of the orientation can be carried out in differentiated time intervals for the detection axes X, Y, Z.

The outputs of the counter modules 23 are connected to respective inputs of the logic module 25, for supplying detection signals S_{DX}, S_{DY}, S_{DZ}, which indicate the orientation of respective detection axes X, Y, Z with respect to the horizontal. The detection signals S_{DX}, S_{DY}, S_{DZ} switch (independently of one another) from a first logic value (for example, “0”) to a second logic value (for example, “1”) when the corresponding inertial signals A_{X}, A_{Y}, A_{Z} become lower than the respective thresholds TH_{X}, TH_{Y}, TH_{Z} and remain in this condition for quite a long time for the corresponding counter modules 23 to reach the respective count thresholds. In practice, then, the detection signals S_{DX}, S_{DY}, S_{DZ} assume the second logic value (“1”) when the corresponding detection axes X, Y, Z remain substantially horizontal, and the first logic value (“0”) otherwise.

The logic module 25 generates the interrupt signal INT starting from the transitions of state of the detection signals S_{DX}, S_{DY}, S_{DZ}, using tables.

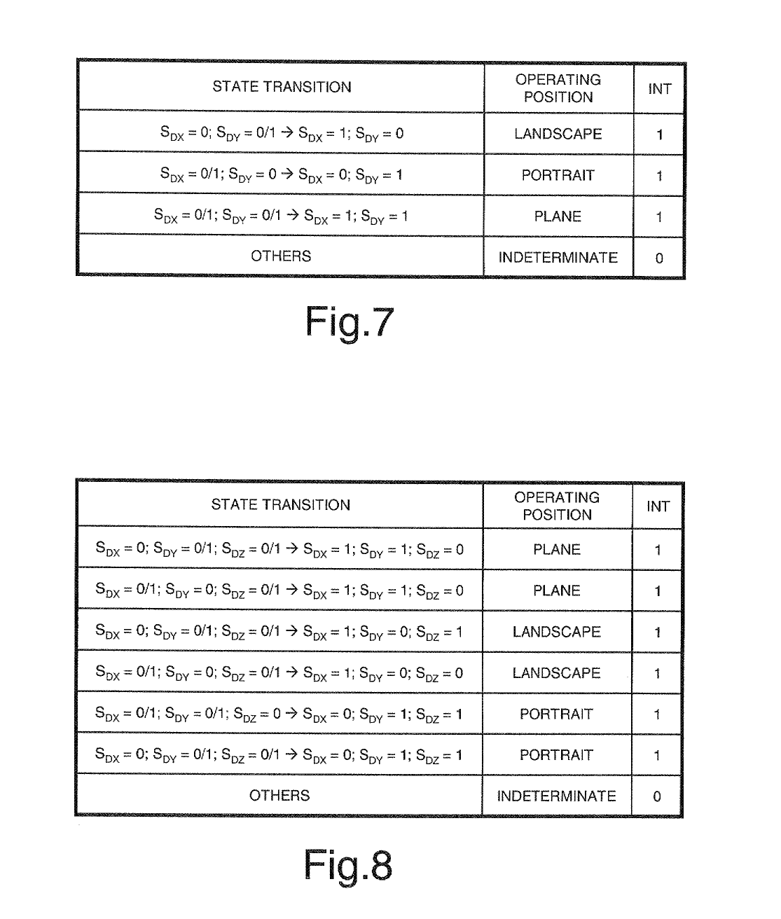

In particular, in one (biaxial) operating mode, the table of FIG. 7 is used. In a different (triaxial) operating mode, the table of FIG. 8 is used. In the tables, the notation “0/1” associated to a detection signal S_{DX}, S_{DY} indicates synthetically that said detection signal S_{DX}, S_{DY} can assume indifferently the first logic value or the second logic value.

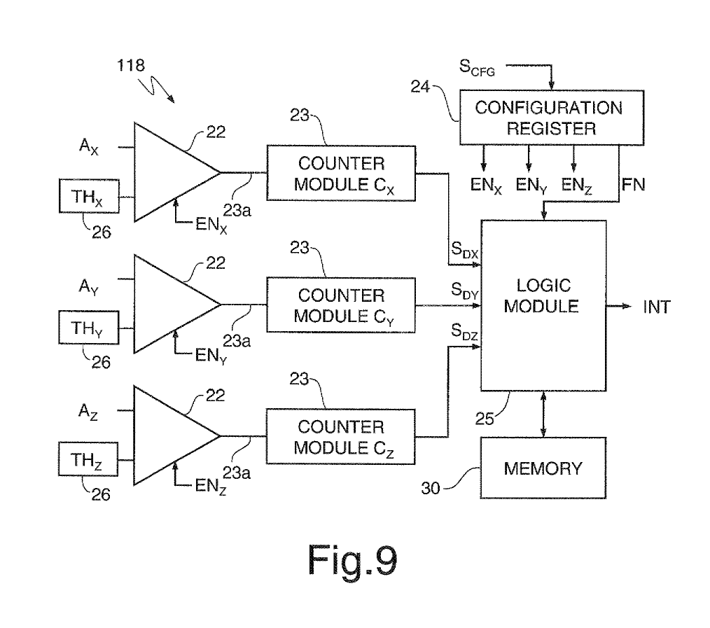

In one embodiment, shown in FIG. 9, the logic module 25 can be provided by a DSP (Digital Signal Processor), an FPGA (Field Programmable Gate Array) or a microprocessor, and is programmable to execute different functions, based upon the detection signals S_{DX}, S_{DY}, S_{DZ}. For example, the interrupt-generator module, here designated by 118, is provided with a nonvolatile memory 30, from which the logic module 25 fetches a sequence of instructions, on the basis of a function FN specified by the control unit 3 in the configuration string S_{CFG}. In particular, the orientation detecting device 10 can be used for implementing functions of free-fall detection, for automatic resuming from standby (“wake-up” function), and the like.

The orientation detecting device 10 described enables reduction to a minimum computational burden on the control unit 3 of the electronic apparatus 1 in which it is incorporated. In fact, the control unit 3 is completely relieved of the operations related to reading the inertial sensor 15 and to processing the inertial or acceleration signals. These operations are, in fact, carried out autonomously and in parallel by the control module 17 and by the interrupt-generator module 18. The control unit 3 is involved only in responding to the interrupt signal INT when the orientation of the electronic apparatus 1 is modified significantly. Also in this case, however, the control unit 3 simply has to fetch the orientation string S_{OR} from the I/O register 20 and accordingly update the sequence of instructions being executed.

The orientation detecting device 10 is moreover flexible. In addition to the possibility of programming the thresholds and the time intervals for recognition of the orientation, the logic module can be reconfigured for executing different functions. In this way, the same physical resources can be shared, for example, by time division, with consequent saving of space and components.

Also other resources necessary for detection of the orientation can be shared for executing further functions. For example, in apparatuses incorporating a photographic camera or a camcorder, the inertial sensor can be used for image stabilization.

It is advantageous also to carry out recognition of the position using as reference a horizontal direction. The sensitivity of the inertial sensor according to a detection axis is in fact greater as the detection axis approaches the horizontal. The inertial sensor can then be exploited to the utmost with regard to both precision and speed of response.

Finally, it is clear that modifications and variations may be made to the device and method described herein, without thereby departing from the scope of the present disclosure.

In particular, the device for detecting orientation can be used in any electronic apparatus in which the execution of the operations can be affected or controlled by means of the position or the change of position of the electronic apparatus itself. Hence, also the functions that exploit the detection of the position can be other than shooting and display of images. For example, in a palmtop computer or in a cell phone, the orientation can be exploited for controlling scrolling functions or functions of navigation in menus, for activating functions, for controlling games, and so forth.

Consequently, it is also evident that the operating position of the electronic apparatus can be determined according to criteria different from the ones schematically illustrated in FIGS. 6 and 7, according to the application for which the device for detecting orientation is used. For example, in a triaxial operating mode, it is possible to include the recognition of operating positions in which only one of the detection axes is substantially horizontal.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An orientation detection device comprising:
an inertial device having a plurality of independent detection axes and configured to provide inertial signals indicative of effects of gravity with respect to the detection axes, respectively; and
a processing unit configured to process the inertial signals wherein the processing unit comprises an interrupt generator module having:
a threshold comparison stage, configured to compare the inertial signals with respective thresholds; and
a logic module having an input, coupled to the threshold comparison stage, and an output, the logic module configured to generate an interrupt signal on the output in response to at least one of the inertial signals remaining below the respective threshold for a time interval.

2. The device according to claim 1 wherein the logic module is configured to generate the interrupt signal in response to two of the inertial signals concurrently remaining below the respective thresholds.

3. The device according to claim 1 wherein the threshold comparison stage comprises a plurality of comparators for each of the detection axes, respectively, and each comparator receives a respective one of the inertial signals.

4. The device according to claim 3 wherein the threshold comparison stage comprises counter modules, controlled respectively by the comparators so as to be selectively activated, when the inertial signal received from the respective comparator is lower than the corresponding threshold, and to be reset otherwise.

5. The device according to claim 4 wherein the counter modules are configured to provide respective detection signals and to switch the respective detection signals on reaching respective counting thresholds.

6. The device according to claim 5 wherein the counting thresholds are programmable.

7. The device according to claim 1 wherein the threshold comparison stage is selectively activatable.

8. The device according to claim 1 wherein the processing unit comprises a control module and an input/output module.

9. The device according to claim 1 wherein the inertial device comprises a MEMS accelerometer.

10. A system comprising:
a control unit; and
an orientation detection device coupled to the control unit, the orientation detection device comprising:
an inertial device having a plurality of independent detection axes and configured to provide inertial signals indicative of effects of gravity with respect to the detection axes, respectively; and
a processing unit configured to process the inertial signals wherein the processing unit comprises an interrupt generator module having:
a threshold comparison stage configured to compare the inertial signals with respective thresholds; and
a logic module having an input, coupled to the threshold comparison stage, and an output, the logic module configured to generate an interrupt signal on the output in response to at least one of the inertial signals remaining below the respective threshold for a time interval.

11. The system according to claim 10, further comprising a display coupled to the control unit and an image sensor coupled to the control unit.

12. The system according to claim 10 wherein the control unit is configured to execute sequences of operations and to update a sequence of operations during execution based on the interrupt signal.

13. The system according to claim 12 wherein the processing unit is configured to load the inertial signals in an input/output module and the control unit is further configured to read the inertial signals from the input/output module in response to the interrupt signal.

14. A method, comprising:
detecting orientation of an electronic apparatus, the detecting including:
detecting inertial signals indicative of effects of gravity according to respective detection axes of the inertial device; and
processing the inertial signals, the processing including:
comparing the inertial signals with respective thresholds; and
sending an interrupt signal to the control unit in response to at least one of the inertial signals remaining below the respective threshold for a time interval.

15. The method according to claim 14 wherein the interrupt signal is sent in response to two of the inertial signals concurrently remaining below the respective threshold.

16. The method of according to claim 14 wherein comparing the inertial signals with respective thresholds occurs in a processing unit independent from the control unit.
